(19) United States
(12) Patent Application Publication
(10) Pub. No.: US 2024/0311629 A1
(43) Pub. Date: Sep. 19, 2024

(54) ONLINE LEARNING METHOD AND ONLINE LEARNING DEVICE

(71) Applicant: TDK CORPORATION, Tokyo (JP)

(72) Inventor: Kazuki NAKADA, Tokyo (JP)

(73) Assignee: TDK CORPORATION, Tokyo (JP)

(21) Appl. No.: 18/121,302

(22) Filed: Mar. 14, 2023

(51) Int. Cl. G06N 3/08

(52) U.S. Cl. CPC G06N 3/08

(57) ABSTRACT

An online learning method includes: compressing a range of possible values of a Kalman gain before an update; obtaining a Kalman gain after the update from the compressed Kalman gain before the update using an expanded Kalman filter method; expanding the range of possible values of the Kalman gain after the update, and updating a weight by adding a weight before the update to a result obtained by multiplying the Kalman gain in which the range of the possible values of the Kalman gain is expanded by an error between a training signal and an inference result in which a weight before the update is used.

### BACKGROUND

### Field

The present invention relates to an online learning method and an online learning device.

### Description of Related Art

Neural networks are mathematical models that mimic networks of nerve cells of brains. Machine learning in which neural networks are used has been examined.

For example, Patent Document 1 discloses a method of implementing an increase in a speed of learning and a reduction in an operation load to implement a neural network on an edge device.

### PATENT DOCUMENTS

[Patent Document 1] PCT International Publication No. WO 2020/261509

### SUMMARY

To implement a neural network on an edge device, a fast learning method is required. Online learning in which a Kalman filter is applied is faster and more stably than in a stochastic gradient method of the related art, but requires more computation and a memory usage. To implement an online learning device on an edge device, an online learning method having efficient memory usage is required.

The present disclosure has been made in view of the foregoing circumstances and provides an online learning method and an online learning device capable of reducing an operation load by nonlinearly compressing and expanding a range of possible values of a Kalman gain in accordance with an operation stage.

According to a first aspect, an online learning method includes: compressing a range of possible values of a Kalman gain before an update; obtaining a Kalman gain after the update from the compressed Kalman gain before the update using an expanded Kalman filter method; expanding the range of possible values of the Kalman gain after the update, and updating a weight by adding a weight before the update to a result obtained by multiplying the Kalman gain in which the range of the possible values of the Kalman gain is expanded by an error between a training signal and an inference result in which a weight before the update is used.

The online learning method and the online learning device according to the aspect are capable of reducing an operation load applied to learning.

### BRIEF DESCRIPTION OF THE DRAWINGS

FIG. 1 is an exemplary block diagram illustrating a learning device according to a first embodiment.

FIG. 2 is a conceptual diagram illustrating an example of a neural network.

FIG. 3 is an exemplary flowchart illustrating a learning program.

FIG. 4 is a diagram illustrating an example of a decimal point notation.

FIG. 5 is a diagram illustrating another example of a decimal point notation.

FIG. 6 is a diagram illustrating an example of a nonlinear function used for compressing a range of possible values of a Kalman gain.

FIG. 7 is a diagram illustrating an example of a nonlinear function used for expanding a range of possible values of a Kalman gain.

FIG. 8 is a diagram illustrating an example of a result obtained by performing an operation using an online learning method according to the first embodiment.

FIG. 9 is a diagram illustrating a distribution of a connection weight when an operation is performed using the online learning method according to the first embodiment.

FIG. 10 is a diagram illustrating an example of a result obtained by performing an operation using an online learning method according to a comparative example.

### DETAILED DESCRIPTION

Hereinafter, embodiments will be described in detail appropriately with reference to the drawings. In the drawing described below, characteristic portions are enlarged for convenience in some cases so that features of the present invention can be clearly understood and ratios or the like of dimensions of constituent elements differ from actual ratios or the like in some cases. Materials, dimensions, and the like exemplified in the following description are exemplary and the present invention is not limited thereto, but can be modified appropriately within the scope of the present invention in which the advantages of the present invention can be obtained.

### First Embodiment

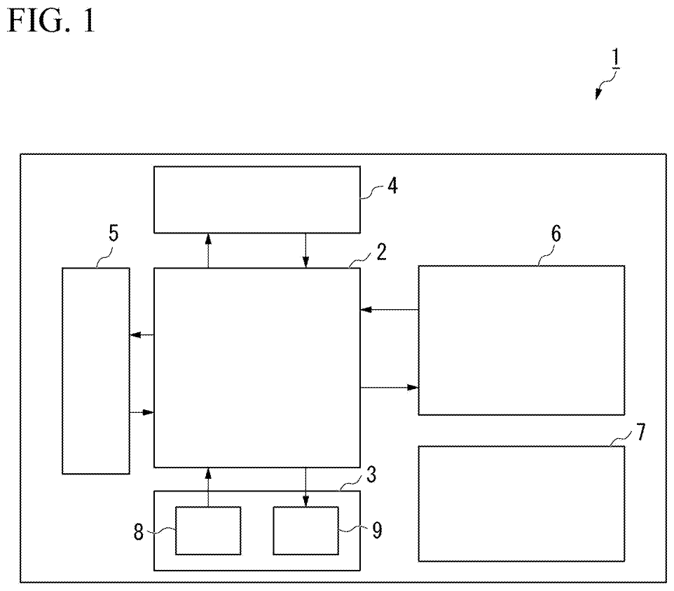

FIG. 1 is an exemplary block diagram illustrating an online learning device 1 according to a first embodiment. The online learning device 1 includes, for example, an operator 2, a register 3, a compressor 4, an expander 5, a memory 6, and a peripheral circuit 7. The register 3 includes, for example, a learning program 8 and an inference program 9.

The online learning device 1 is implemented on, for example, a microcomputer or a processor. The online learning device 1 operates by causing the operator 2, the compressor 4, and the expander 5 to execute a program recorded on the register 3. The memory 6 stores an operation result of the operator 2.

The compressor 4 compresses a range of possible values of a Kalman gain used for an operation based on the learning program 8. The expander 5 expands the range of the possible values of the Kalman gain used for an operation based on the learning program 8. Each of the compressor 4 and the expander 5 may be, for example, a dedicated hardware operator. A dedicated hardware operator is, for example, an application specific integrated circuit (ASIC) or a field programmable gate array (FPGA).

The peripheral circuit 7 includes a circuit or the like that controls these units. The online learning device 1 performs, for example, a process based on a neural network or a dynamical system.

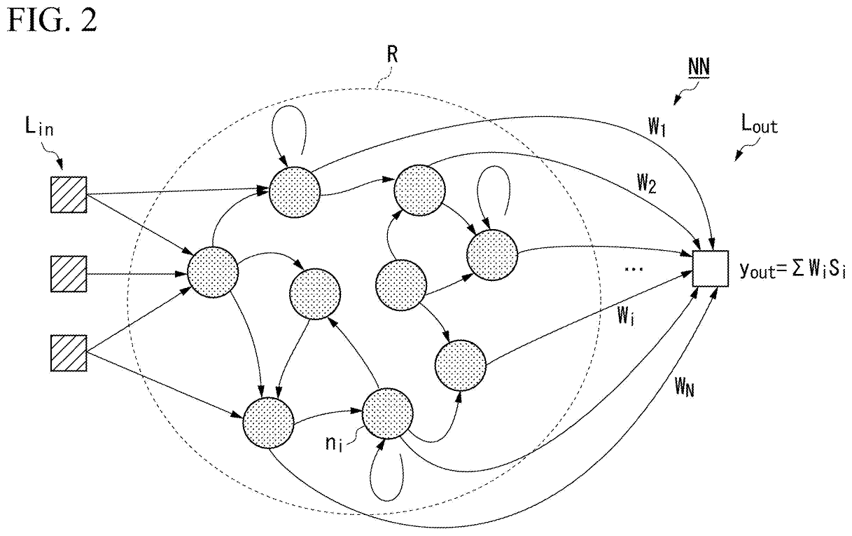

FIG. 2 is a conceptual diagram illustrating an example of a neural network NN. The neural network NN includes an input layer Lᵢₙ, a reservoir layer R, and an output layer Lₒᵤₜ.

The reservoir layer R includes a plurality of nodes nᵢ. The number of nodes nᵢ does not particularly matter. Hereinafter, the number of nodes nᵢ is assumed to be N. Each of the nodes nᵢ may be replaced with, for example, a physical device. The physical device is, for example, a device capable of converting an input signal into vibration, an electromagnetic field, a magnetic field, spin waves, for the like.

Each of the nodes nᵢ interacts with neighboring nodes nᵢ. For example, a connection weight is defined between the nodes nᵢ. The connection weight corresponds to a weight of Claims. The number of defined connection weights is the number of combinations of connections between the nodes nᵢ. Each of the connection weights between the nodes nᵢ is defined in principle, and thus does not vary due to learning. Each of the connection weights between the nodes nᵢ is arbitrary, and they may coincide with each other or differ. Some of the connection weights between the plurality of nodes nᵢ may vary due to learning.

Input signals are input from the input layer Lᵢₙ to the reservoir layer R. The input signals are input from, for example, externally provided sensors. The input signals propagate between the plurality of nodes nᵢ in the reservoir layer R to interact with each other. The interaction of signals refers to an influence of signals propagating in certain nodes nᵢ on a signal propagating in other nodes nᵢ. For example, when an input signal propagates between the nodes nᵢ, a connection weight is applied to the input signal and varies. The reservoir layer R projects an input signal to a multi-dimensional nonlinear space.

An input signal input to the reservoir layer R is replaced with another signal. At least some information included in the input signal is retained in a varied form.

One or more signals Sᵢ are sent from the reservoir layer R to the output layer Lₒᵤₜ. A connection weight wᵢ is applied to each of the signals Sᵢ output from the reservoir layer R. The output layer Lₒᵤₜ performs a product operation of applying the connection weight wᵢ to the signal Sᵢ and a sum operation of adding each product operation result. The connection weight wᵢ is updated in a learning stage and inference is performed based on the updated connection weight wᵢ.

The neural network NN performs learning to raise an answer rate for a task and performs inference to output a reply to the task based on a learning result. The learning is performed based on the above-described learning program 8. The inference is performed based on the above-described inference program 9.

When the operator 2 executes the inference program 9, a reply to the task is output. The online learning device 1 performs an inference operation of inferring a reply to a set task. The smaller an error between an inference result and a training signal is, the higher an answer rate is.

The learning program 8 updates the connection weight w; using an expanded Kalman filter method. The online learning device 1 performs a specified online learning method based on the learning program 8.

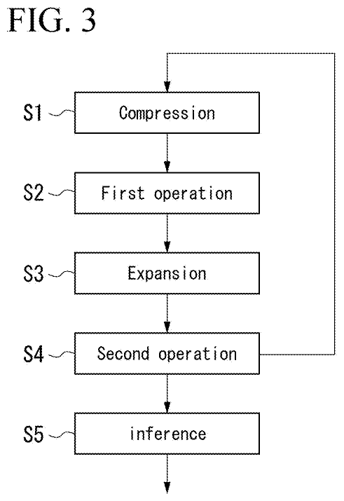

FIG. 3 is a flowchart illustrating an online learning method according to the first embodiment. The online learning method according to the first embodiment includes a compression step S1, a first operation step S2, an expansion step S3, a second operation step S4, and an inference step S5. In the online learning method, the compression step S1, the first operation step S2, the expansion step S3, the second operation step S4, and the inference step S5 are repeated to sequentially update the connection weight wᵢ.

In the compression step S1, a range of possible values of a Kalman gain before an update is compressed. For example, the compressor 4 performs the compression step S1.

The Kalman gain is a coefficient used to update the connection weight wᵢ. An update equation of the Kalman gain in the expanded Kalman filter is expressed in the following Expression (1). P(t) is a covariance matrix and the update equation is expressed in the following Expression (2). r(t) is a state variable in the reservoir layer R and expresses a state of each node nᵢ.

$$K ( t ) = P ( t - 1 ) {r ( t ) [ 1 + {r}^{T} ( t ) P ( t - 1 ) r ( t ) ]}^{- 1} = P ( t ) r ( t ) \qquad ( 1 )$$

$$P ( t ) = P ( t - 1 ) - K ( t ) {r}^{T} ( t ) P ( t - 1 ) \qquad ( 2 )$$

As indicated in Expressions (1) and (2), the Kalman gain is obtained by operating a covariance matrix. A Kalman gain K(t) after the update (current) is obtained from a covariance matrix P(t-1) before the update (previous). A covariance matrix P(t-1) before the update (previous) can be obtained from the Kalman gain before the update. In the compression step S1, to inhibit divergence of the Kalman gain after the update (current), a range of possible values of the Kalman gain before the update (previous) is compressed.

Here, the range of the possible values of the Kalman gain varies, for example, when a decimal point notation of the Kalman gain is changed. The Kalman gain can be expressed in any floating-point format.

As a decimal point notation, there are a floating-point format and a fixed-point format. In the floating-point format, there is a floating-point binary number (real number) or a floating-point decimal number (real number). Hereinafter, the decimal point notation will be described as a floating-point decimal number format. In the decimal point notation, there are elements of a word length, a radix, a sign part, a decimal part (also referred to as a mantissa part), and an exponential part. The word length is the number of digits which can be allocated in one unit of a process of a computer. The radix is a number indicating the number of digits of a base. The sign part indicates a sign attribute and 0 or 1 is allocated. The decimal part is a part for an effective number and indicates a value of a decimal point or less. The decimal point notation can be made in any floating-point format and, for example float32 or bfloat16 can be applied. The decimal point notation may be made in any fixed-point format. The exponential part is, for example, a part indicating n of an n-th power of the radix. A scientific notation is a system indicating an exponent notation format in a floating point.

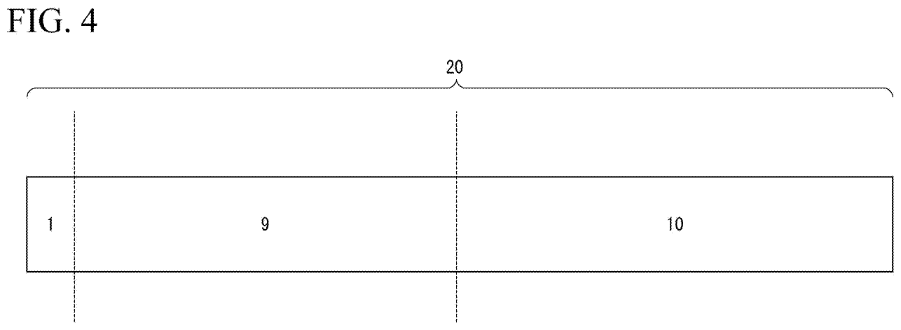

FIG. 4 is a diagram illustrating an example of a decimal point notation of a floating-point format. The decimal point notation of the floating-point format illustrated in FIG. 4 has a word length of 20, a sign part length of 1, an integer part length of 9, and a decimal part length of 10.

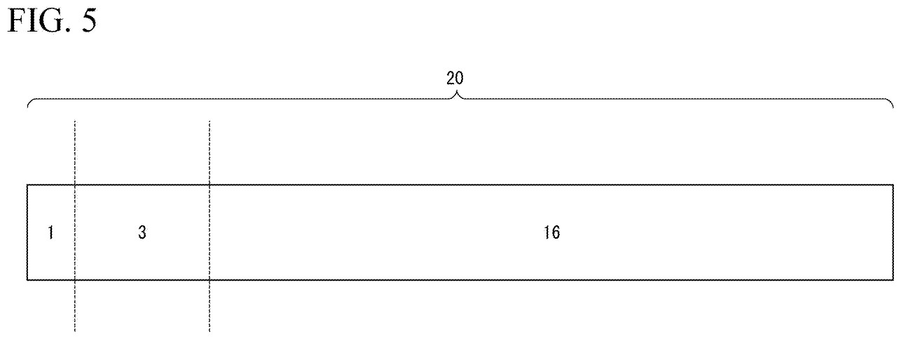

FIG. 5 is a diagram illustrating another example of the decimal point notation of the floating-point format. The decimal point notation of the floating-point format illustrated in FIG. 5 has a word length of 20, a sign part length of 1, an integer part number of 3, and a decimal part length of 16.

For example, a range of possible values of a floating-point number varies in accordance with a ratio of the decimal part length to the word length. When the ratio of the decimal part length to the word length increases, a ratio of the integer part number to the word length decreases. The exponent part is a parameter indicating the number of digits of a value. The lower a ratio of the exponent part to the word length is, the smaller an upper limit of an expressible value is. For example, when a value “512” is expressed in the decimal point notation illustrated in FIG. 4, the value is “511.9990.” When the value “512” is expressed in the decimal point notation illustrated in FIG. 5, the value is “8.0000.” Since the decimal point notation illustrated in FIG. 5 has a small upper limit of an expressible value, the value “512” is compressed to “8.0000.”

When the ratio of the decimal part length to the word length increases, the range of the possible values is narrowed and compressed. The range of the possible values of a Kalman gain can be compressed, for example, by raising a ratio of the decimal part length to the word length in the decimal point notation of the Kalman gain. In the compression step S1, for example, a Kalman gain expressed by a word length of 20 and a decimal part length of 10 is re-expressed by a word length of 20 and a decimal part length of 16.

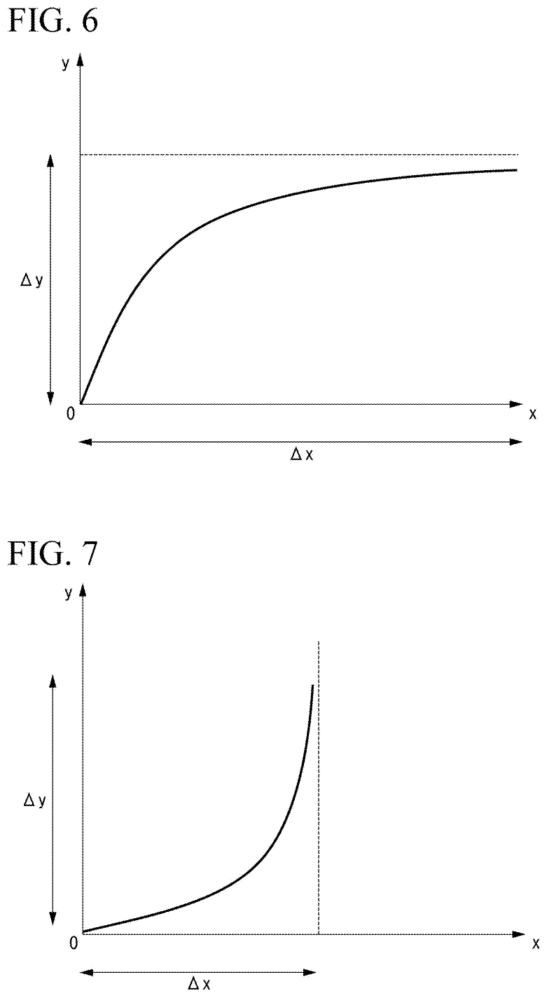

The range of the possible values of the Kalman gain may be compressed by substituting an original value of the Kalman gain into a nonlinear function. The nonlinear function is, for example, a logarithmic function. FIG. 6 is a diagram illustrating an example of a nonlinear function used for compressing a Kalman gain. A possible value Δx of x is infinite, but a possible value Δy of y obtained by nonlinearly converting x is a finite value. That is, when the Kalman gain is substituted into the nonlinear function, the range of the possible values of the Kalman gain can be compressed.

In the first operation step S2, a compressed Kalman gain after the update is obtained from a Kalman gain before the update using an expanded Kalman filter method. The first operation step S2 is performed by the operator 2.

In the first operation step S2, operations of the foregoing Expressions (1) and (2) are performed. For the covariance matrix P(t-1) before the update, a dynamic range is compressed in the compression step S1. The state variable r(t) is also expressed in a similar bit notation to the covariance matrix. Therefore, the range of the possible values of the Kalman gain after the update is obtained in a compressed state.

For example, when the Kalman gain before the update compressed in the decimal point notation with a word length of 20 and a decimal part length of 16 is indicated, the Kalman gain after the update is also expressed in the decimal point notation with a word length of 20 and a decimal part length of 16.

In the expansion step S3, the range of the possible values of the Kalman gain after the update is expanded. The expansion step S3 is performed by, for example, the expander 5.

The range of the possible values of the Kalman gain is expanded, for example, by lowering a ratio of the decimal part in the decimal point notation of the Kalman gain.

For example, in the expansion step S3, the Kalman gain expressed in a decimal point notation with a word length of 20 and a decimal part length of 16 is re-expressed in a decimal point notation with a word length of 20 and a decimal part length of 10. Here, the example in which the Kalman gain is returned to the decimal point notation before the compression has been described. However, the range of the possible values of the Kalman gain may be expanded by re-expressing the Kalman filter in a decimal point notation different from the decimal point notation before the compression. For example, the Kalman gain expressed in a decimal point notation with a word length of 20 and a decimal part length of 16 may be re-expressed in a decimal point notation with a word length of 16 and a decimal part length of 8 or may be re-expressed in a decimal point notation with a word length of 8 and a decimal part length of 4.

The range of the possible values of the Kalman gain may be expanded by substituting the Kalman gain into a nonlinear function. FIG. 7 is a diagram illustrating an example of a nonlinear function used for expanding a range of possible values of a Kalman gain. The nonlinear function is, for example, an exponential function. A possible value Δx of x is finite, but a possible value Δy of y obtained by nonlinearly converting x is infinite. That is, when the Kalman gain is substituted into the nonlinear function, the range of the Kalman gain can be expanded.

In the second operation step S4, an operation of updating the connection weight wᵢ is performed. The second operation step S4 is performed by the operator 2.

A connection weight wᵢ(t) after the update is obtained by adding a result of multiplication of the Kalman gain K(t) and an error e(t) to the connection weight wᵢ(t-1) before the update. The error e(t) is an error between a training signal d(t) and an inference result z(t) using the connection weight wᵢ(t-1) before the update. Update of the connection weight wᵢ(t) is expressed in the following Expression (3).

$$w ( t ) = w ( t - 1 ) + K ( t ) e ( t ) \qquad ( 3 )$$

In Expression (3), w(t) is a connection weight after the update and w(t-1) is a connection weight before the update. K(t) is a Kalman gain and the range of the possible values of the Kalman gain is expanded in the expansion step S3. e(t) is an error and is expressed in the following Expression (4).

$$e ( t ) = d ( t ) - z ( t ) = d ( t ) - {w}^{T} ( t - 1 ) r ( t ) \qquad ( 4 )$$

In Expression (4), d(t) is a training signal and z(t) is an inference result using the connection weight before the update.

The connection weight after the update may be quantized more than the connection weight before the update. For example, when the connection weight before the update is expressed in a first decimal point notation, the connection weight after the update is expressed in a second decimal point notation. In the second decimal point notation, the word length and the decimal part length are shorter than in the first decimal point notation.

For example, when the connection weight before the update is expressed in a decimal point notation (the first decimal point notation) with a word length of 20 and a decimal part length of 10, the connection weight after the update is expressed in a decimal point notation (the second decimal point notation) with a word length of 16 and a decimal part length of 8.

When the decimal point notation of the Kalman gain in the expansion step S3 is quantized more than the decimal point notation of the Kalman gain before the update, the connection weight after the update is quantized more than the connection weight before the update. When the connection weight at the time of updating of the connection weight is low-quantized, operation efficiency is improved and usage efficiency of a memory is improved.

A process of quantizing the connection weight after the update more than the connection weight before the update may be performed in a process separate from the quantization of the Kalman gain. For example, when the word length is the same before and after the update, the quantization process may be performed as a separate process. In the quantization, a rounding process of replacing the decimal part with an approximate value is performed. The rounding process is, for example, a process of rounding the decimal part to a closest integer. When closest integers are at an equal distance, the decimal part is rounded to an absolute value.

The connection weight after the update is stored in the memory 6. The connection weight after the update may be stored in the memory 6 with being low-quantized.

The inference step S5 is an operation of performing an inference process using the updated connection weight. The inference step S5 is performed by the operator 2 using the connection weight stored in the memory 6. When an error between an inference result and training data is equal to or less than a constant value, the process ends. When the error between the reference result and the training data is greater than the constant value, the process of updating the connection weight is repeated again. The updating process is repeated until the error between the inference result and the training data becomes equal to or less than the constant value.

The online learning device according to the embodiment compresses the range of the possible values of the Kalman gain when the Kalman gain is calculated, and expands the range of the possible values of the Kalman gain when the connection weight is updated. The Kalman gain can be inhibited from diverging by constraining the range of the possible values of the Kalman gain when the Kalman gain is calculated. The operation efficiency when the connection weight is updated is improved through the low-quantization when the connection weight is updated.

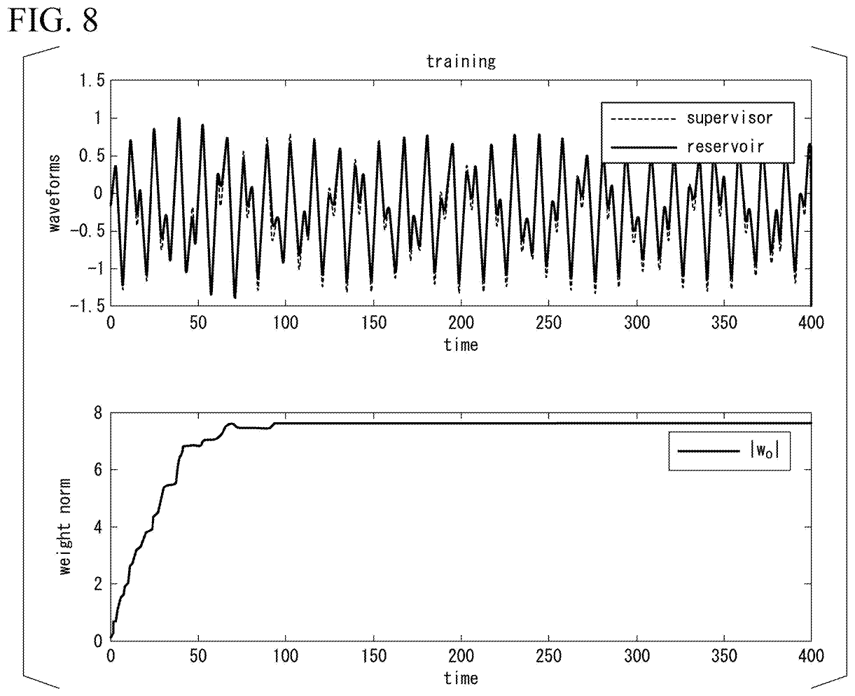

FIG. 8 is a diagram illustrating an example of a result obtained by performing an operation using an online learning method according to the first embodiment. In the online learning illustrated in FIG. 8, the Kalman gain after compression is expressed in a decimal point notation with a word length of 20 and a decimal part length of 16 and the Kalman gain after compression is expressed in a decimal point notation with of a word length of 16 and a decimal part length of 8.

An upper graph of FIG. 8 shows a comparison result between a training signal and an output signal (an inference result) from the online learning device. In the upper graph of FIG. 8, a solid line indicates an inferred value and a dotted line indicates the training signal. The lower graph of FIG. 8 shows a change in a total sum (norm) of the connection weight over time. As illustrated in FIG. 8, the total sum of the connection weight converges to a constant value, and the training signal and the inferred value are sufficiently matched.

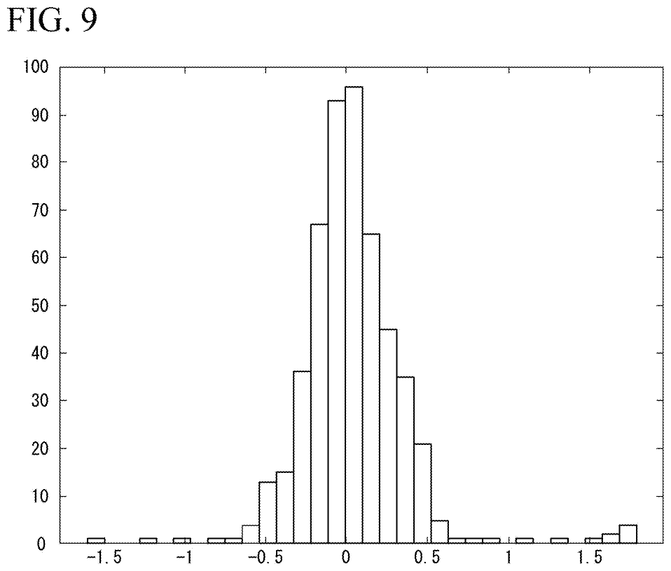

FIG. 9 is a diagram illustrating a distribution of a connection weight when an operation is performed using the online learning method according to the first embodiment. In FIG. 9, the horizontal axis represents a value of the connection weight and the vertical value represents the number of connection weights of specific values. The connection weight illustrated in FIG. 9 has a statistical property closes to a normal distribution. Therefore, output signals output from units duplicated by the expanded Kalman filter method appropriately vary. When the output signals appropriately vary, prediction accuracy of a task is improved.

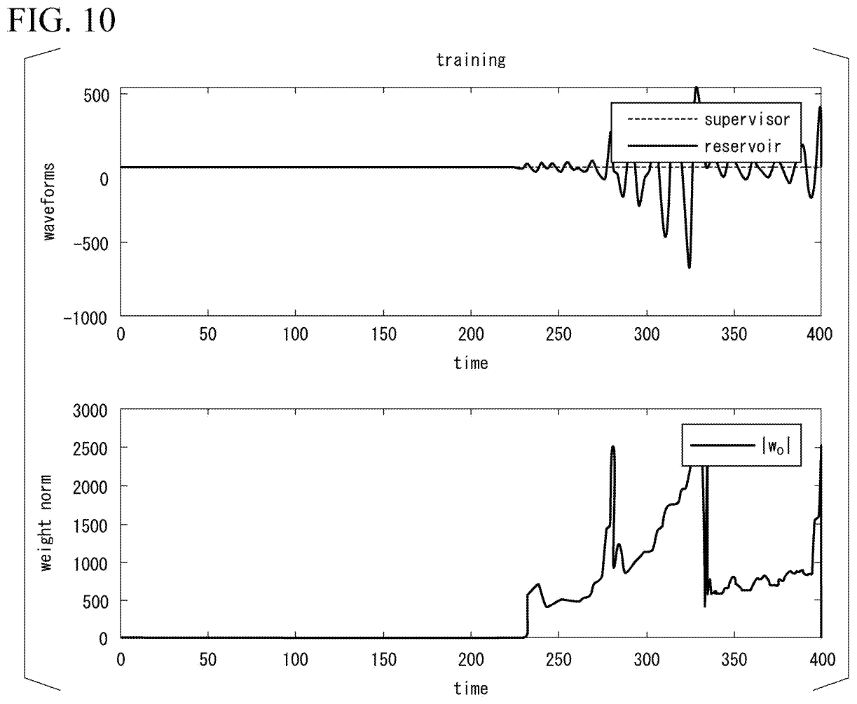

FIG. 10 is a diagram illustrating an example of a result obtained by performing an operation using an online learning method according to a comparative example. In the online learning illustrated in FIG. 10, the range of the possible values of the Kalman gain was not compressed and expanded. In the online learning method according to the comparative example, the Kalman gain was expressed in a decimal point notation with a word length of 20 and a decimal part length of 10 and an operation was performed in either the first operation step or the second operation step.

An upper graph of FIG. 10 shows a comparison result between a training signal and an output signal (an inference result) from the online learning device. In the upper graph of FIG. 10, a solid line indicates an inferred value and a dotted line indicates the training signal. The lower graph of FIG. 10 shows a change in a total sum (norm) of the connection weight over time.

As illustrated in FIG. 10, a covariance matrix diverged during learning and the learning did not stably converge. Therefore, as illustrated in FIG. 10, the training signal and the inferred value were not matched.

The preferred aspects of the present invention have been exemplified above according to the first embodiment, but the present invention is not limited to this embodiment. For example, the decimal point notation may be a floating-point binary number format or a fixed point format.

Here, an example in which the learning program is applied to a reservoir network which is one recurrent neural network has been described above, but the present invention is not limited thereto. For example, the learning program may be applied to updating of a weight of a hierarchical feed forward neural network. When a parameter is updated chronologically, the invention is not limited to a neural network. For example, the learning program may be applied to a state estimation of a deterministic dynamical system.

### Explanation of References

1 Online learning device
2 Operator
3 Register
4 Compressor
5 Expander
6 Memory
7 Peripheral circuit
8 Learning program
9 Inference program
R Reservoir layer
NN Neural network
Lᵢₙ Input layer
Lₒᵤₜ Output layer
S1 Compression step
S2 First operation step
S3 Expansion step
S4 Second operation step
S5 Inference step

What is claimed is:

1. An online learning method comprising:
compressing a range of possible values of a Kalman gain before an update;
obtaining a Kalman gain after the update from the compressed Kalman gain before the update using an expanded Kalman filter method;
expanding the range of possible values of the Kalman gain after the update, and
updating a weight by adding a weight before the update to a result obtained by multiplying the Kalman gain in which the range of the possible values of the Kalman gain is expanded by an error between a training signal and an inference result in which the weight before the update is used.

2. The online learning method according to claim 1, wherein the weight after the update is quantized by being expressed in a second decimal point notation in which a word length and a length of a decimal part are shorter than the weight before the update expressed in a first decimal point notation.

3. The online learning method according to claim 2,
wherein the weight expressed in the second decimal point notation is maintained in learning, and
wherein the weight expressed in the second decimal point notation is used in inference.

4. The online learning method according to claim 1, wherein the Kalman gain is expressed in an arbitrary decimal-point format.

5. An online learning device comprising:
a compressor, an operator, and an expander,
wherein the compressor compresses a range of possible values of a Kalman gain before an update,
wherein the operator performs a first operation to obtain a Kalman gain after the update from the compressed Kalman gain before the update using an expanded Kalman filter method and performs a second operation to update a weight by adding a weight before the update to a result obtained by multiplying the Kalman gain in which the range of the possible values of the Kalman gain is expanded by an error between a training signal and an inference result in which the weight before the update is used, and
wherein the expander expands the range of the possible values of the Kalman gain after the update.
